(19) United States
(12) Patent Application Publication
(10) Pub. No.: US 2020/0199931 A1
(43) Pub. Date: Jun. 25, 2020

(54) Door System

(71) Applicant: Schöning GmbH, Dortmund (DE)

(72) Inventor: Waldemar Hübner, Helmenzen (DE)

(21) Appl. No.: 16/634,736

(22) PCT Filed: Jul. 26, 2018
(86) PCT No.: PCT/EP2018/070305

§ 371 Date: Jan. 28, 2020

(30) Foreign Application Priority Data
Jul. 28, 2017 (DE) 10 2017 007 097.0

(51) Int. Cl. E06B 3/48; E05F 15/673; E05F 15/686; E06B 9/06

(52) U.S. Cl. CPC E06B 3/48; E05F 15/673; E05F 15/686; E05Y 2900/11; E06B 9/0676; E05Y 2900/106; E06B 9/0638

(57) ABSTRACT

The invention relates to a door system (1) comprising a door (2) and two lateral guide elements (4, 5), wherein the door (2) comprises multiple slat elements (6) which are connected to one another and can be detached from one another, and which are arranged orthogonal to the guide elements (4, 5) and can be guided in the guide elements (4, 5), and a drive device (8) is provided for opening and/or closing the door(2), wherein the door (2) can be lowered and/or raised for opening and/or closing and can be lowered into a box (9) for opening, and the individual slat elements (6) are arranged next to one another inside the box (9) in an open state of the door (2). The drive device (8) is a cable pulley system (10) which can be driven by a horizontal drive spindle (11) and wherein a cable (12) of this pulley system (10) is connected to at least one slat element (6) in the vertical direction (V).

The present invention relates to a door system and in particular to a door system comprising a door that can be sunk. Doors for blocking off and restricting travel into and out of private premises, company property, or else buildings such as garages and halls have long been known. In particular, conventional sliding doors and swing doors are used for this purpose, which are opened as soon as a vehicle wishes to travel in or out. However, these known door systems have the drawback that they have an enormous space requirement, in particular in the open state or for opening, and also, for the open door position, a space at least equally as large as in a closed door position generally has to be kept free, since in most cases the door is slid to the right or left or pivoted inward about an axis for opening In particular the radius that is required for opening very large doors requires considerable space, which has to be kept constantly clear, both in the closed state (so as to make this opening possible in the first place) and in the open state of the door. As a result, it is not uncommon for valuable, expensive space, in many cases even one or more automobile parking spaces, to be blocked off.

Therefore, the object of the present invention is to provide a door system that eliminates the aforementioned drawbacks and in particular has a low space requirement in an open state or for opening. Moreover, the drive for opening and closing the door should be formed to be as simple and low-maintenance as possible.

A door system according to the invention thus comprises a door and two lateral guide elements, the door comprising multiple slat elements that are connected to one another and can be detached from one another, and that are arranged orthogonal to the guide elements and can be guided in the guide elements, and a drive device being provided for opening and/or closing the door, the door being able to be lowered and/or raised for opening and/or closing and to be sunk into a box for opening, and the individual slat elements being arranged next to one another inside the box in an open state of the door.

According to the invention, the drive device is a pulley system that can be driven by a horizontal drive spindle, and a cable of this pulley system is connected to at least one slat element in the vertical direction.

Arranging the individual slat elements next to one another inside the box in an open state of the door should be understood to mean that for opening the door the individual slat elements are sunk below the ground and preferably sunk and lowered, respectively, in a horizontal direction, and during the sinking advantageously separated from one another and arranged inside the box as individual elements. The installation depth of the box accordingly does not have to correspond to the height of the entire door, but merely to the height of a slat element.

In a preferred embodiment, the box therefore has a depth between 30 cm and 100 cm, preferably between 50 cm and 80 cm and particularly preferably of 70 cm. This relatively small installation depth of the box thus makes possible a compact arrangement of the door in the open state, and results in a lower installation outlay than an installation depth corresponding to the entire height of the door. This small installation depth is therefore achieved in particular by the construction of the door from a plurality of individual slat elements. The individual slat elements thus additionally have the advantage that as a result the height of the door can be individually adapted in a very simple manner, in particular even in pre-existing door systems of this type.

Preferably, the individual slat elements have a width, height, and thickness or depth that are individually adaptable to the requirements and customer specifications in each case. Hereinafter, the width of the slat is also referred to as the broad side and the thickness or depth as the narrow side. Moreover, in the context of the slats, upward and downward are referred to, upward being understood to mean the broad side of the slat located upward in the installation position, and downward being understood to means the broad side of the slat located downward in the installation position.

Preferably, the door has a large number of slat elements and the individual slat elements are connected to one another at least in a closed state of the door. Advantageously, the individual slat elements are connected to one another via a positive connection, it being possible for the slats each to have suitable means on the narrow sides for this purpose. In particular, the slat elements have connection means on both narrow sides, so as to be connected to the preceding and following slat. Preferably, it would also be conceivable for one slat element to be hooked into another slat element. In this case, the slat elements are preferably formed in such a way that the slat elements have a type of hook on the lower and/or upper broad side thereof and correspondingly a recess or opening on the upper and/or lower broad side thereof, into which the previous and/or following slat element can accordingly be hooked by means of the hook. Accordingly, the slat element located uppermost in the installation position thus has no opening and/or no hook on the upper broad side thereof, and the slat element located lowermost in the installation position has no hook and/or no opening on the lower broad side thereof in the installation position.

In a further preferred embodiment, the slats have a chamfer on the narrow sides thereof, and in particular a slope that is preferably between 45° and 135°. These narrow sides advantageously make it possible for the narrow sides to slide along on one another during the transition from the closed position to the open position and vice versa, in other words when the slat elements are lowered or raised in the horizontal direction. The opening and closing of the door can preferably be controlled by way of a wireless remote control, a light barrier or the like.

In an advantageous embodiment, the lateral guide elements extend in a vertical direction and the slat elements are arranged between the two guide elements in a horizontal direction. Preferably, the slat elements have on the narrow sides thereof at least one roller by way of which the slats can be guided inside the guide elements.

In a particularly preferred embodiment, the box is arranged below the door system and in particular below the plane characterizing the ground surface. For opening, it is accordingly proposed not to slide or pivot the door over or above the ground, as is conventional in the art, but rather to sink it below the ground surface. Preferably, the box has a locking mechanism at ground level so as to lock the box once the door is completely open. Preferably, this locking mechanism closes automatically once the door has been completely opened. This creates a flat surface over the box so that a vehicle can travel over it. Advantageously, the slat elements are accordingly arranged completely inside the box, and thus below the ground surface, in a fully opened state of the door. It is thus also conceivable for the slat elements to be connected to one another again inside the box, for which purpose connecting elements are accordingly arranged laterally on the narrow sides of the slats. As a result of the slat elements being connected in this manner inside the box, a compact arrangement of the slats in the box can be achieved, since as a result one slat can be arranged very close to the next slat.

Inside the box, at least one further guide rail is advantageously arranged, into which the slats are diverted when the door is opened. Preferably, in this context the slats are also guided inside this guide rail by way of the roller arranged on the narrow side of the slats. Preferably, this guide rail is arranged horizontally. Particularly preferably, the box has two further guide rails of this type, and in particular each guide element is connected to a further guide rail. Preferably, the guide elements and guide rails are accordingly arranged mutually orthogonally and in particular at an angle of 90° to one another.

In a further advantageous embodiment, the pulley system further has at least one first roller and one second roller via which the cable can be guided substantially in a vertical direction. Advantageously, in this context at least one of the rollers is formed in such a way that the cable can be wound onto this roller at least in part and/or unwound from this roller at least in part.

Particularly preferably, at least one roller of the pulley system is connected to the horizontal drive spindle. Advantageously, the door system has two pulley systems of this type, which are connected to one another by way of the horizontal drive spindle, a pulley system being guided in each of the guide elements.

In a preferred embodiment, the drive device further has a drive motor that is arranged above the ground surface. Advantageously, the drive device is an electric motor, such as a worm gear motor or the like.

Accordingly, the door is opened by driving the drive spindle by means of the drive device, setting in rotation the drive spindle and thus also the rollers connected to said drive spindle. This rotation of the rollers also sets the cable in motion, and thus drives the first rollers of the two pulley systems. Since the cable additionally has at least one connection to the first or uppermost slat element, the movement of the rollers and of the cable lowers the door downward into the box. For closing the door, the drive spindle is correspondingly set in rotation again, the direction of rotation for closing the door being counter to the direction of rotation for opening the door.

In a further advantageous embodiment, the pulley system has a sensor device, which is preferably suitable and intended for monitoring and/or checking a tension of the cable. Preferably, in this embodiment the pulley system has a third roller, which is preferably arranged below the first roller in a vertical direction and offset from the first roller and/or the second roller in a horizontal direction.

If stones or other objects that cause the door to jam are now located in the region of the door system, or if the door is positioned on an object at at least one point, or if stones or objects of this type are wedged inside the door system, the tension of the rope eases. This is recognized in the sensor device, the sensor device preferably comprising a magnet and a spring for this purpose, in such a way that when the cable is relaxed or slack the spring is preferably also relaxed, it being possible in turn for this to lead to a signal preferably being outputted to the door control, in such a way that for example the door is caused to be stopped during an opening and/or closing movement. Preferably, the sensor device therefore has a spring, which, when the cable is under tension, is likewise tensioned.

Using this mechanism, slipping of the cable out of one of the rollers can preferably also be detected at an early stage, since the tension of the cable likewise eases as a result. Moreover, the sensor device could preferably also comprise a measurement device that detects a length of the cable that has passed through the sensor. By way of this cable length, it can preferably be established or determined what position the door is actually in.

Preferably, the sensor device is accordingly a type of safety monitoring system or safety device, which ensures correct or error-free actuation of the door system as a function of the tension of the cable.

Advantageously, the slat elements are plate-like elements or a grid structure. The material of the slat elements is preferably a metal, a plastics material, wood or the like. Preferably, the slat elements can also provide visual protection. The configuration and (color) design of the door is thus individually adaptable to a wide range of customer wishes.

In a further advantageous embodiment, the door system may have a device for manual winding, in such a way that the door can be opened and closed manually for example in the event of a power failure. To set this manual operation in action, for example a fingerprint sensor and/or number code lock may also be arranged on the door system. Further, it would also be conceivable for the door system to have a light barrier and/or mechanical monitoring, in such a way that the door cannot be closed or opened when a person or objects have been detected.

The door system according to the invention is in particular used as a barrier to premises and company property. However, it is also conceivable for the door system to be used in a garage, in which case the slat elements are moved upward to open the door and the box is accordingly arranged on the garage ceiling.

Further advantages and embodiments can be derived from the accompanying drawings, in which:

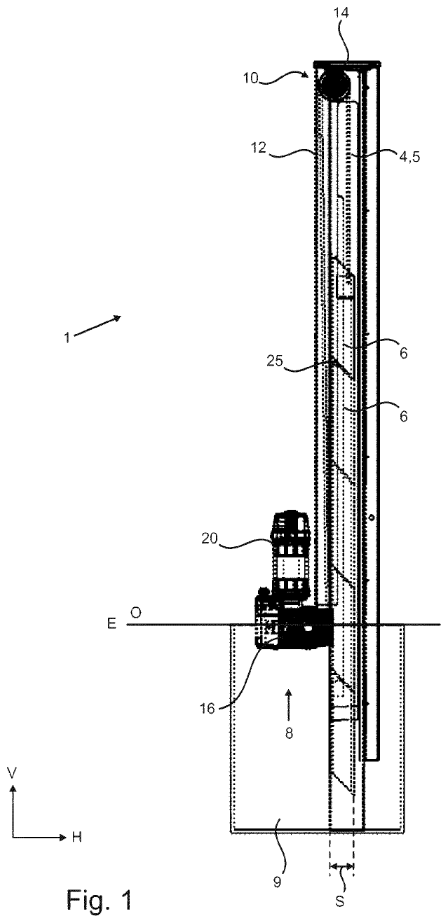

FIG. 1 is a schematic drawing of a side view of a door system according to the invention;

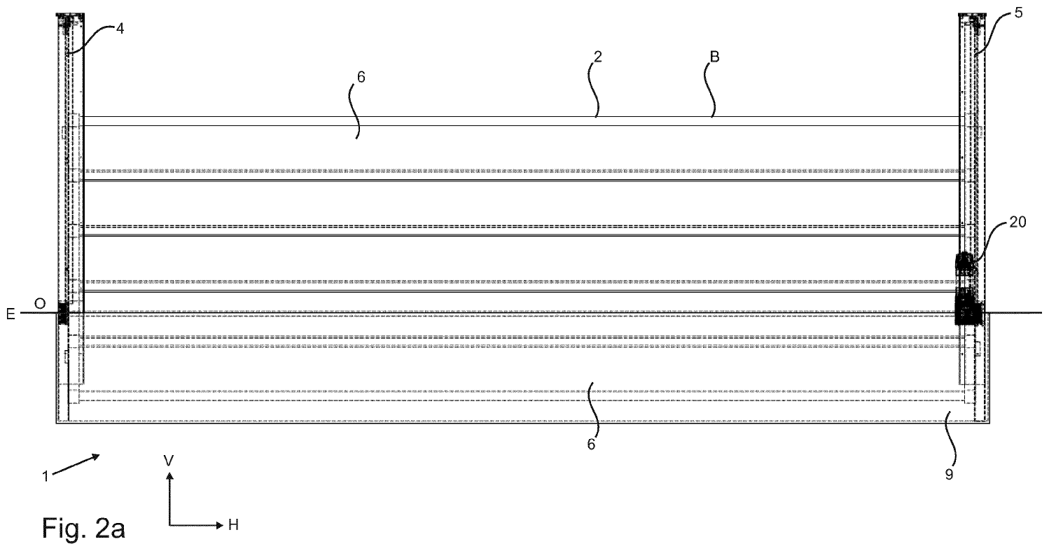

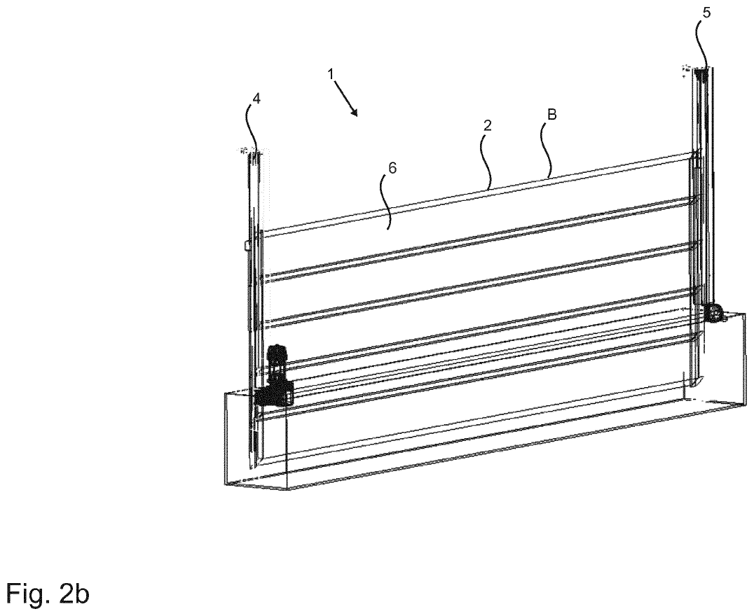

FIG. 2a a schematic drawing of front view of a door system according to the invention;

FIG. 2b a three-dimensional drawing of a front view of a door system according to the invention;

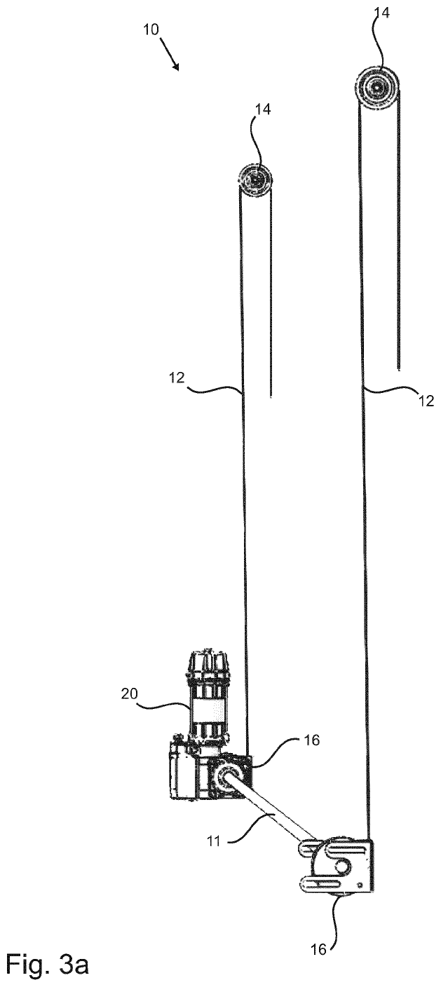

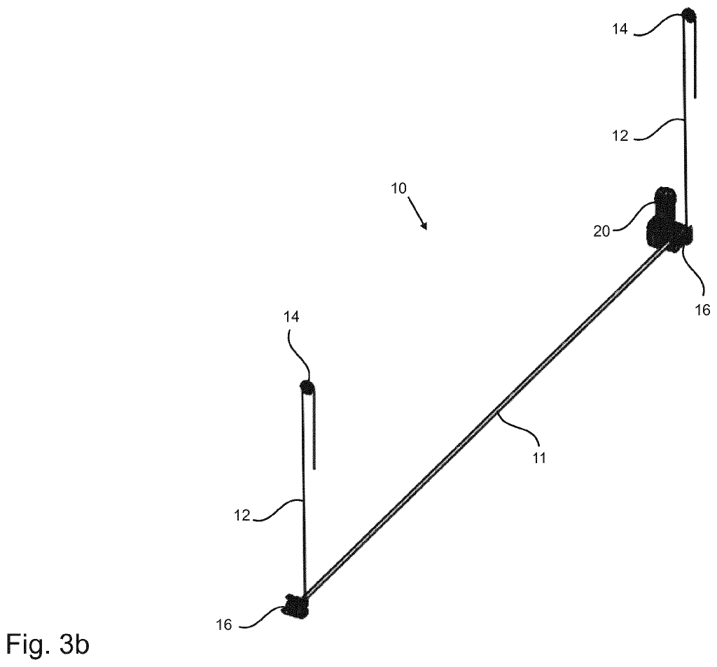

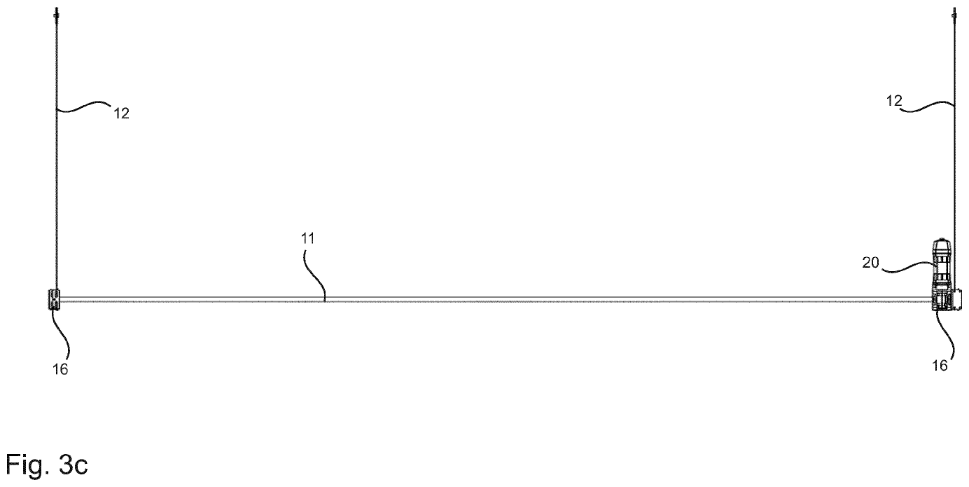

FIG. 3a a three-dimensional drawing of the pulley system;

FIG. 3b a further three-dimensional drawing of the pulley system;

FIG. 3c a schematic drawing of a front view of the pulley system;

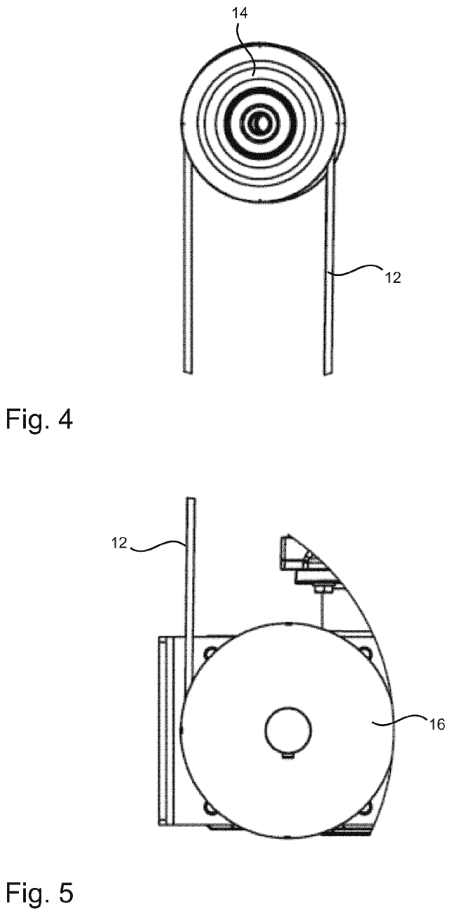

FIG. 4 a detail of a first roller of the pulley system;

FIG. 5 a detail of a second roller of the pulley system;

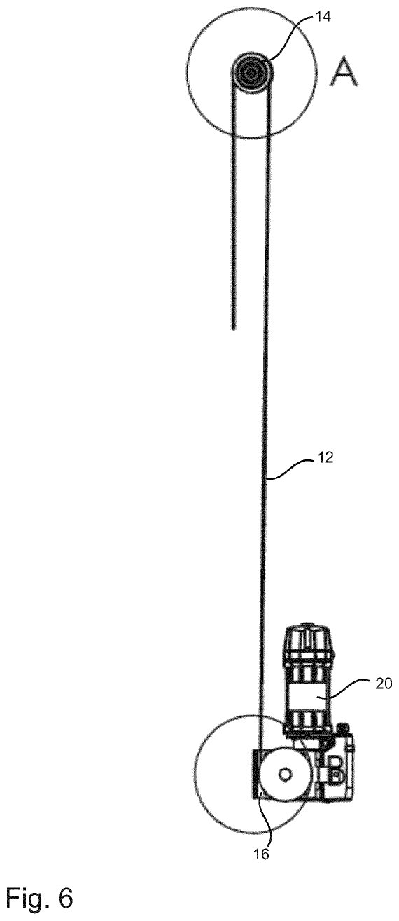

FIG. 6 a detail of a pulley system;

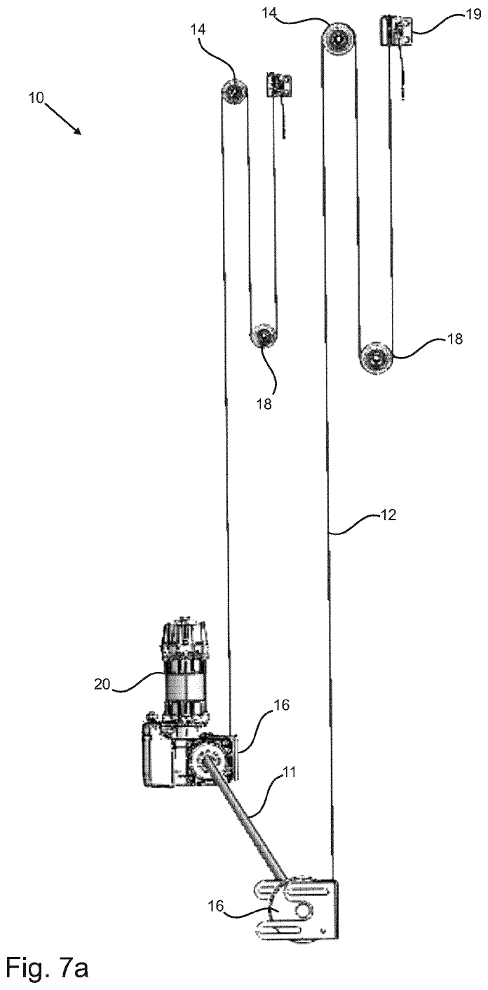

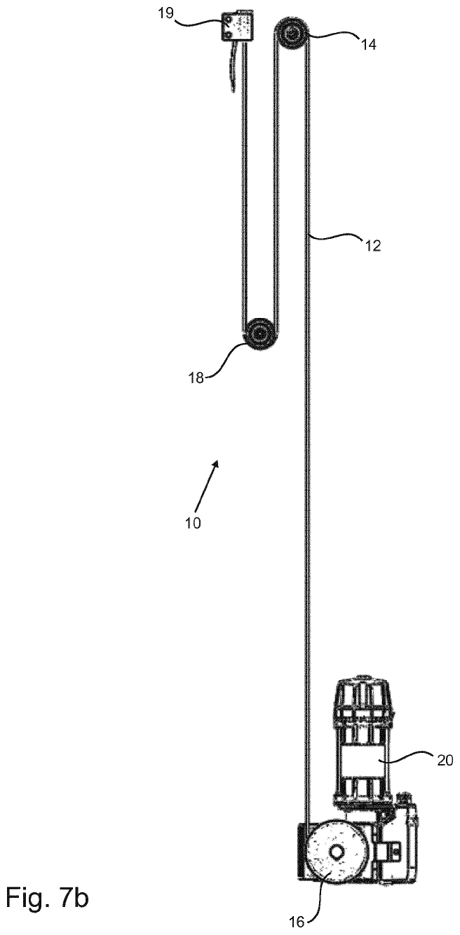

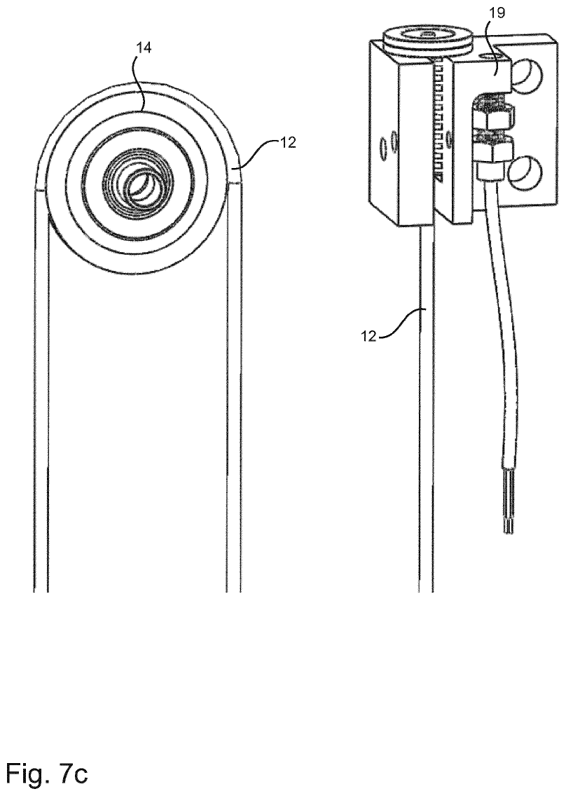

FIG. 7a a schematic drawing of a second embodiment of the pulley system;

FIG. 7b a further drawing of the second embodiment of the pulley system;

FIG. 7c a detail of the pulley system according to the second embodiment.

FIG. 1 is a schematic drawing of a side view of a door system 1 according to the invention. Therein, reference numeral 8 denotes a drive device that is used for opening and closing the door. In the embodiment according to the invention, a pulley system 10 is provided as a drive device, and comprises in particular a first roller 14, a second roller 16, a cable 12, a drive motor 20 and a drive spindle (not visible in this drawing). A narrow side S of the slat elements 6 is also visible in this drawing, the slat elements 6 having a chamfer or slope 25 on the upper and lower narrow side S.

Moreover, reference numeral E denotes a plane of the ground surface O, and reference numeral 9 denotes the box, which is arranged below this ground surface O and serves to receive the slat elements 6 during an open state of the door.

Moreover, FIGS. 2a and 2b are a front view of the door system 1 according to the invention. Reference numeral B denotes the broad side of the slat elements 6. In this drawing, in particular the orthogonal relationship between the door 2 or the slat elements 6 and the guide elements 4 and 5 is visible, the guide elements 4 and 5 extending in a horizontal direction H and the slat elements 6 in a vertical direction V.

FIG. 3a-3c show the aforementioned pulley system 10. In this case, there are preferably two pulley systems 10 of this type, one system, or the cable 12 and the rollers 14 and 16 (not visible from the outside), being arranged in each of the guide elements 4 and 5. It can be seen that the two second rollers 16 are connected to one another via a drive spindle 11, and the drive spindle 11 is driven by way of a drive motor 20. Arranging two pulley systems of this type is advantageous in particular because this can make uniform opening and closing of the door possible, and there is no risk of for example the side of the door on which no pulley system is arranged tilting inside the guide element.

FIGS. 4 and 5 are each a detail of the aforementioned first roller 14 and second roller 16. In this case, preferably, the first roller 14 is a roller around which the cable 12 is merely guided when the door is opened and closed, and the second roller 16 is a roller around which the cable 12 is wound and unwound when the door is opened and closed.

FIG. 6 is a further detail of the pulley system 10, in particular the arrangement or connection of the cable 12 and the rollers 14, 16 being visible here.

FIG. 7a-7c show a further embodiment of the pulley system, this being in particular a pulley block system. By contrast with the embodiment shown in FIG. 1-6, in this case the pulley system 10 additionally has a third roller 18, in such a way that the cable 12 is guided over three rollers 14, 16, 18 in total. This third roller 18 is preferably arranged below the first roller 14 in a vertical direction and offset from the first roller 14 and/or the second roller 16 in a horizontal direction, as can be seen in particular from FIGS. 7a and 7b.

Here, reference numeral 19 denotes a sensor device, which, as was explained in greater detail above, is in particular for monitoring a tension of the cable, in such a way that for an untensioned cable for example the opening and/or closing movement of the door can be interrupted or stopped. Preferably, a sensor device of this type may also be provided in the embodiments of FIG. 1-6.

The Applicant reserves the right to claim all features disclosed in the application documents as essential to the invention so long as they are novel, individually or in combination, in respect of the prior art. It is further noted that the individual drawings have also described features that may be advantageous in their own right. A person skilled in the art will immediately recognize that a particular feature described in a drawing may be advantageous even without the incorporation of further features from said drawing. A person skilled in the art will further recognize that advantages may also result from a combination of a plurality of features shown in individual or in different drawings.

### LIST OF REFERENCE NUMERAL

1 Door system

2 Door

4, 5 Guide elements

6 Slat element

8 Drive device

9 Box

10 Pulley system

11 Drive spindle

12 Cable

14 First roller

16 Second roller

18 Third roller

19 Sensor device

20 Drive motor

25 Slope

E Plane

O Ground surface

H Horizontal direction

V Vertical direction

S Narrow side of the slat element 6

B Broad side of the slat element 6

1. A door system, comprising:
a door;
two lateral guide elements;
wherein the door a plurality of slat elements connected to one another and selectively detachable from one another and arranged orthogonal to and guided in the guide elements,
a drive device configured to open or close the door, the door being able to be lowered or raised and sunk into a box, wherein individual slat elements are arranged next to one another inside the box when the door is in an open state; and
wherein the drive device is a pulley system that can be driven by a horizontal drive spindle, and wherein a cable of the pulley system is connected to at least one slat element in the vertical direction.

2. The door system according to claim 1, wherein the lateral guide elements extend in a vertical direction (V) and the plurality of slat elements are arranged between the two guide elements in a horizontal direction (H).

3. The door system according to claim 1, wherein the box is arranged below the door system.

4. The door system according to claim 1, wherein the box has a depth between 30 cm and 100 cm.

5. The door system according to claim 1, wherein the pulley system has at least one first roller and one second roller via which the cable can be guided substantially in a vertical direction.

6. The door system according to claim 1, wherein at least one of the rollers is formed in such a way that the cable can be wound onto this roller at least in part and/or unwound from this roller (16) at least in part.

7. The door system according to the preceding claims, wherein at least one roller of the pulley system is connected to the horizontal drive spindle.

8. The door system according to claim 1, wherein the door system has two pulley systems, which are connected to one another by way of the horizontal drive spindle, a pulley system being guided in each of the guide elements.

9. The door system according to claim 1, wherein the drive device further has a drive motor arranged above a ground surface (O).

10. The door system according to claim 1, wherein the plurality of slat elements are plate-like elements or a grid structure.

11. The door system according to claim 1, wherein the pulley system has a sensor device, which is suitable for monitoring or checking a tension of the cable.
